(19) United States
(12) Patent Application Publication
(10) Pub. No.: US 2011/0265914 A1
(43) Pub. Date: Nov. 3, 2011

(54) Tankless Exothermic Torch

(75) Inventors: James J. Reuther, Worthington, OH (US); Richard W. Givens, Columbus, OH (US)

(73) Assignee: BATTELLE MEMORIAL INSTITUTE, Columbus, OH (US)

(21) Appl. No.: 13/054,486

(22) PCT Filed: Jul. 15, 2009
(86) PCT No.: PCT/US2009/050722

§ 371 Date: Apr. 2, 2011

Related U.S. Application Data
(60) Provisional application No. 61/081,718, filed on Jul. 17, 2008.

(51) Int. Cl. B23K 7/08; B23K 20/00; B23K 7/06

(52) U.S. Cl. 148/199; 266/48; 228/101

(57) ABSTRACT

A thermite torch is disclosed that contains a thermite composition made of a bimodal mixture of nano-sized particles and micro-sized particles. Also disclosed is a tankless exothermic torch comprising a rod and a handle that contains a gas generating compound in the handle. The thermite torch gun does not require a tank of compressed gas. Elimination of this tank mitigates dangers and logistical burdens associated with it presence and use, without compromising operation or cutting performance. The rod may contain a high-density mixture of oxygen-releasing and/or heat-releasing chemicals. Preferably, the mixture comprises a bimodal-blend of nanometer and micrometer-sized particles in a closely-packed configuration to fill interstitial voids. The gun may contain an ignition module and power supply for initiating directed high-temperature flame jetting, and for turning it on/off/on when a solid-chemical oxygen generator is mounted in the gun.

### RELATED APPLICATIONS

This application claims the priority of PCT/US2009/050722 (WO 2010/009250) filed 15 Jul. 2009. This application also claims the priority of U.S. Provisional Patent Application Ser. No. 61/081,718, filed 17 Jul. 2008.

### FIELD OF THE INVENTION

This invention relates to a portable, handheld exothermic cutting torch that does not require the use of a tank of high-pressure compressed gas to perform effective cutting.

### INTRODUCTION

Direct-action breaching operations in the global-war-on-terrorism and in civilian demolition and construction often require non-explosive cutting torches in urban, remote, or underwater locations. Fielded torches employ an expendable exothermic rod coupled to a tank of compressed gas (oxygen, O₂, or air) to cut reinforcing metal plates or rods in or about walls, doors, or windows. The high-temperature abrasive flow and cutting rates achieved by these exothermic rods are proportional to the rate of gas supplied to the solid-state thermitic reactions initiated in the rod.

Risks and burdens result from the presence and use of a tank of compressed gas, especially O₂, which is a potential bomb. The tank's presence adds to hazards under both combat and civilian conditions, not only to the operator holding it, but also to team members nearby. Because military cutting operations are often conducted in hostile environments, any directed or stray projectile impacting the O₂ tank, hose, or regulator could result in catastrophic rupture, a fireball, and shrapnel that could immolate and penetrate and injure or kill the user and surrounding personnel.

The user must also bear the burden of the tank system's weight and bulk, along with other mission-essential equipment. The dimensions, weights, and numbers of rods that can be expended are limited to the capacity and supply rate of the O₂ tank. Tanks increase the difficulty of cutting operations in remote or hindered spaces, adversely affecting work efficiency. The logistical support (refilling) and routine maintenance (cleaning and calibrating) required by tanks and regulators for handling compressed O₂ are challenging and expensive not only under combat but also under peacetime conditions.

The tankless exothermic torch eliminates the need for pressurized tanks of gas by combining solid-state oxidants with thermitic fuels in the rod or by loading them into the gun (FIG. 1). This approach eliminates the safety and logistical liabilities of carrying pressurized tanks of gas, while maintaining the cutting efficiency of current exothermic torches.

### PRIOR PUBLICATIONS

There have been numerous publications describing thermitic torches and thermitic compositions.

U.S. Pat. No. 4,352,397 (Christopher, 1982) “Methods, Apparatus and Pyrotechnic Compositions for Severing Conduits”, teaches that particles sizes for the exothermic constituents need only to be “powdered”, with no specification for any particle size.

U.S. Pat. No. 4,371,771 (Faccini, et al., 1983) “Cutting Torch and Method”, teaches that an exothermic metal, aluminum, can be a “powder, ribbon, or particle”, and that “The . . . physical form . . . is not critical.”

U.S. Pat. No. 4,432,816 (Kennedy, et al., 1984) “Pyrotechnic Composition for Cutting Torch”, teaches that, “The particle size of the aluminum should not be larger than 100 mesh (150 microns) and the particle size of the ferric oxide not larger than about 200 mesh (75 microns) and not smaller than one micrometer.”

U.S. Pat. No. 4,432,816 (Kennedy, et al., 1984); U.S. Pat. No. 5,472,174 (Geasland, 1995) “Thermal Cutting Bar”, U.S. Pat. No. 5,888,447 (Smith, et al., 1999) “Self-Extinguishing Burning Bar”; and U.S. Pat. Appl. 2004/0041310 and 2004/0041310 (Hlavacek, et al., 2004) all teach that cutting is more efficient if the rod contains a “plurality”, “bundle”, or “core” of “axially extending members or wires” to direct O₂ flow through these physical passageways.

U.S. Pat. No. 6,183,569 (Mohler, 2001) “Cutting Torch and Associated Methods”, teaches “. . . the charge density of thermite charge is preferably in the range from about 50% to 67% of its theoretical maximum density. It will be appreciated by those skilled in the art that the density of the powder of thermite charge is balanced to provide reliable ignition and to maximize the cutting action.”

U.S. Pat. No. 6,627,013 (Carter, et al., 2003) “Pyrotechnic Thermite Composition” and U.S. Pat. Appl. 2003/0145752 (Carter, et. al., 2003) “Portable Metal Cutting Pyrotechnic Torch” teach that heat and oxygen-generating powders and binders, when combined, “. . . decrease the rate of the reaction”, and should have “. . . an average grain size under 10 microns”. Moreover, U.S. Pat. No. 6,627,013 teaches that the “exothermic reaction proceeds at a slower rate as composition density is increased.” This patent also mentions that thermitic compositions can include 0-20% by weight of supplemental oxidizing agents such as metal oxides, chlorates (including NaClO₃), perchlorates, peroxides, nitrites and nitrates. U.S. Pat. Appl. 2003/0145752 teaches a “polymeric binder” must be used to avoid “. . . cracks which result in discontinuities . . . in the matrix resulting in an irregular burn and burn rate.”

Although it does not relate to thermite, U.S. Pat. No. 4,589,356 (Adams, et al., 1086) “Energy Recovery from Biomass Using Fuel Having a Bimodal Size Distribution”, discloses that in biomass, such as wood and peat, ignition is enhanced if 10% by weight of the normal-sized particles (10 millimeters, or 1000 microns) is replaced with particles “less than 100 micrometers in diameter”.

In another publication unrelated to thermite torches, Zhang, et al. in U.S. Pat. No. 6,071,329 (2000) “Filter for Chemical Oxygen Generator”, describe a granular aggregation of particles having a particle size of approximately 20 to 100 mesh (150 to 850 microns), the particles being formed from a mixture of hopcalite particles and lithium hydroxide. These teachings are repeated in U.S. Pat. Nos. 6,143,196 (Zhang, et al., 2000), 6,193,907 and 6,231,816 (Zhang, et al., 2001).

For generating breathable oxygen, U.S. Pat. No. 6,054,067 (Zhang, et al., 2000) “Low Temperature Sensitivity Oxygen Generating Compositions”, teaches that although a non-oxygen generating additive can be “ground to pass 60 mesh (250 microns) to facilitate mixing”, “and although more finely ground powder will be more effective, and coarser powder will be less effective, granular anhydrous sodium metasilicate that is finer or coarser can be expected to work, and may also be suitable” The same teachings are repeated in U.S. Pat. Nos. 6,296,689 (Zhang, et al., 2001) and 6,352,652 (Zhang, et al., 2002). Likewise, U.S. Pat. No. 5,882,545 (Zhang, et al., 1999) “Oxygen Generating Compositions”, teaches that a non-oxygen generating additive “with particles sizes smaller than 325 mesh (45 microns) is preferred even though coarser powder also works in a satisfactory way.”

The references described above have not identified the use of ultra-small particles (nanometric dimensions); multiple particle-size distributions (bimodal); or particular packings (Keplerian) to improve the performance of exothermic torches, either because their application was unrecognized or expected to result in negative effects, such as greatly accelerating the reaction rate and subsequent shortening of the operating lifetime of the rod or oxygen generator.

### SUMMARY OF THE INVENTION

This invention involves blending micron-sized heat and oxygen-releasing powders into the rod, or micron-sized O₂-releasing powders in the gun, with specific amounts of powders with small-enough diameters (1-100 nanometers) to fit into the interstitial voids about the micron powders at weight fractions high enough to: 1) cause close packing within the voids to moderate heat and oxygen release but not adversely affect (increase) their rate of reaction; and 2) increase the density of the oxygen-generating chemical high enough levels to generate allow storage volumes and flowrates to equal to those of a tank of compressed oxygen, thereby allowing its elimination without compromising cutting performance.

Test and calculations (M. Pantoya, et al., 2004, “Thermite Combustion Enhancement Resulting from Bimodal Aluminum Distribution”, 31^{st} International Pyrotechnics Seminar, page 262; and M. Pantoya, et al., 2005 “Combustion Velocities and Propagation Mechanisms of Metastable Interstitial Composites”, Journal of Applied Physics, Vol. 98, page 064903) reveal that “combining nano-scale with bulk-scale particles in a bimodal distribution does not significantly increase the burn rate . . . ” over the specific level of from about 20% to about 40% of nano-sized particles added. These data are shown in FIG. 7 of the above-cited reference for the case of adding 80 nanometer aluminum (Al) powder to 20 micrometer Al powder in 10% increments. Because the objective of their study was to enhance the combustion rate of micron-sized thermitic powders by the addition of nano-sized ones, Pantoya, et al., fail to recognize the significance of being able to do so without accelerating reaction rate, a desired attribute of this invention. Also of significance, Pantoya, et al., reported that “using a bimodal distribution with a narrow second mode will reduce the variance in the burn rate”, which we have recognized as useful for improving the performance of exothermic torches and oxygen generators.

A fundamental tenant of the science of reaction kinetics is that the rate at which a powder reacts to release heat or oxygen is inversely proportional to the square of its radius (see M. Pantoya, et al., 2004, “The Effect of Size Distribution on Burn Rate in Nanocomposite Thermites”, Combustion Theory and Modeling, Volume 8, page 555). That is, as the radius of a powder decreases, its reaction rate increases. Therefore, if nanometer-sized powders were used instead of micrometer-sized ones, or added to them to create a bimodal-size distribution, the rate at which heat or oxygen were released from these thermitic or oxygen-containing chemicals would be expected to increase. However, increased reaction rate may be undesirable in thermite torches since the torch could overheat and prove difficult to operate, and would burn down faster and require replacement.

According to theories established for characterizing close-packing configurations of particles, limits exist for the maximum density attainable by random or selective packing. In terms of random packing (A. Matheson, 1974, “Computation of a Random Packing of Hard Spheres”, Journal of Physics C: Solid State Physics, Volume 7, page 2569), the maximum density attainable by a monomodal size particle size distribution is about 64%, which is comparable, within experimental uncertainty, to the 67% identified in U.S. Pat. No. 6,183,569 (Mohler, 2001) as the maximum density achievable for the thermites tested. In terms of selective packing (N. Sloane, 1998, “Kepler's Conjecture Confirmed”, Nature, Volume 395, page 435), the maximum density attainable by a monomodal particle size distribution is 74%.

In summary, it has been recognized and demonstrated by the inventors that within specific limits, the addition of nano-sized particles to micron-sized particles yields a higher density packing of heat and oxygen-releasing chemicals with a more uniform, but not accelerated, reaction rate.

In one aspect, the invention provides a thermite torch comprising a thermite composition, wherein the thermite composition comprises 10% to 40% nanoparticles and 50% to 90% microparticles.

In another aspect, the invention provides a thermite torch comprising a thermite composition, wherein the thermite composition comprises at least 10% nanoparticles, wherein the composition has a stable burn rate, such that, when tested by blending in an additional 10% of the nanoparticles and formed into a 10% modified rod, the burning rate of the rod made of the 10%-added composition increases by 10% or less when compared to the burn rate of a rod of the thermite composition; in this test, both rods are made by weighing percentages of nanoparticle powders; filling them into a thin-wall 0.5 inch (1.3 cm) inner diameter steel tube; and then agitating the tube by tumbling or vibration to achieve maximize packing density. Preferably, the thermite composition comprises 10% to 40% nanoparticles and 50% to 90% microparticles.

In a further aspect, the invention provides a thermite composition comprising a bimodal distribution of nano and microparticles, comprising from 5% to 70% nanoparticles, 29 to 94% microparticles, and at least 1% of an O2 generator. The invention also includes a thermite torch comprising this composition, or any of the thermite compositions described anywhere in the following descriptions.

In another aspect, the invention provides a thermite composition comprising a bimodal distribution of nano and microparticles, comprising from 5% to 70% nanoparticles, 29 to 94% microparticles, and at least 1% of an O2 generator.

In a further aspect, the invention provides a thermite torch, comprising: a thermite rod attached to a handle; wherein the handle comprises a compartment comprising an O2 generating solid, and a conduit connecting the compartment with the thermite rod.

The invention also includes a method of welding or cutting metal, comprising: igniting any of the torches described herein, and using the molten metal released by the torch to weld or cut a metal substrate.

In some preferred embodiments, the thermite composition comprises one or any combination of the following features: at least 1% of an O2 generator; wherein the nanoparticles are in the size range of 1-100 nanometer and wherein the microparticles are in the 1-10 micrometer range; 10 to 20% aluminum (Al) with about 80 to 90% metal oxide, and at least 1% of chlorate or perchlorate. In some preferred embodiments, the thermite composition does not contain wires or ribbons.

In some preferred embodiments, the thermite torch comprises a handle, a thermite rod comprising the thermite composition, a thermal shield disposed between the handle and the thermite rod, and a nozzle at one end of the thermite rod.

The inventive torches, thermite compositions, and methods of cutting or welding may be further characterized by any one or any combination of the features described in the Detailed Description section.

### BRIEF DESCRIPTION OF THE DRAWING

FIG. 1. Exothermic torch rod and gun.

### DETAILED DESCRIPTION OF THE INVENTION

The thermite composition may use any combination of the metal fuels, metal-oxide oxidants, and alkali-metal oxides developed in the prior art for heat or oxygen-generation. These include, but are not limited to, thermitic combinations of about 10 to 20% aluminum (Al) with about 80 to 90% metal oxide. The metal fuels may include, but are not limited to: aluminum (Al), silicon (Si), zirconium (Zr), beryllium (Be), magnesium (Mg), barium (Ba), titanium (Ti), and boron (B). The metal oxides may include, but are not limited to: iron oxide (Fe₂O₃), copper oxide (CuO), cobalt oxide (CoO), nickel oxide (Ni₂O₃), antimony oxide (Sb₂O₃), molybdenum oxide (MoO₃), chromium oxide (Cr₂O₃,), lead oxide (Pb₂O), and tungsten oxide (WO₃). The compositions may also contain oxygen-generating alkali metals such as ferrates (FeO₄) or perchlorates (ClO₄). Preferably, the composition does not contain any metal wires or binders.

The thermite composition may also comprise 10% to 60%, preferably 25% to 40% O2 generating materials such as chlorates, perchlorates, or ferrates. When an oxygen-generating material is present, the ratio of metal fuel to metal oxide is preferably in the range of 9:1 to 4:1 by weight.

Throughout all the descriptions herein, “%” refers to weight %. Packing density is the volume percent (%) occupied by solids.

Preferably, the thermite composition comprises a bimodal mixture of nanometer and micrometer-sized powders, with the contribution of the nano-sized particles ranging from 5% to 70%, preferably 10% to 40%, and in some embodiments 25% to 35%. Preferably, the thermite composition comprises 30% to 95% microparticles, more preferably 60% to 90% microparticles, and still more preferably 65% to 75% microparticles. Preferably, the thermite composition has a packing density of 65% or greater, preferably greater than 67%, and more preferably 69% or greater.

In this invention, nano-sized particles are defined as particles having a particle diameter in the range of 1 nm to 990 nm, more preferably 1 nm to 500 nm, more preferably 1 to 99 nm, and still more preferably 1 nm to 9 nm. Micro-sized particles have a diameter of between 1 μm and 1 mm, preferably between 1 μm and 500 μm, more preferably between 1 μm and 10 μm, and in some embodiments 1 μm to 3 μm. The invention can be defined by any combination of the above-described weight percents and particle size ranges; for example, 5% to 70% nanoparticles in the size range of 1 to 500 nm; or 5% to 70% nanoparticles in the size range of 1 to 99 nm; or 5% to 70% nanoparticles in the size range of 1 to 9 nm; or 25% to 35% nanoparticles in the size range of 1 to 99 nm; or 5% to 70% nanoparticles in the size range of 1 to 500 nm and 60% to 90% microparticles in the size range of 1 μm and 500 μm; or 10% to 40% nanoparticles in the size range of 1 to 9 nm and 60% to 90% microparticles in the size range of 1 μm and 10 μm; etc. In some preferred embodiments, the nano-sized particles (or simply nanoparticles) are one of either the metal fuel or the metal oxide in the thermite pair.

Particle size and the particle size distribution are to be determined by ASTM WK8705 for particles that can be suspended in liquid. For particles that cannot be suspended, particle size distribution is measured by scanning electron microscopy (SEM) such as by the procedure referred to by Granier et al. in “The effect of size distribution on burn rate in nanocomposite thermites: a probability density function study,” Combustion Theory and Modeling, 8 (2004), 555-565. For compacted materials, particle size is determined by SEM measurement.

Precise particle size distribution is sometimes difficult to measure. The invention can alternatively be characterized by properties of the thermite composition. Preferably, the thermite comprises a mixture of nanoparticles and microparticles containing at least 10% nanoparticles, which, after blending (using tumbling or ultrasonic vibration) in an additional 10% of the nanoparticles, the burn rate of a rod made of this composition increases by 10% or less. This characterization is often simple to carry out using the same particles used to prepare a desired thermite composition. In this test, the velocity (burn rate) is measured as described in Pantoya, et al., 2004, “Thermite Combustion Enhancement Resulting from Bimodal Aluminum Distribution.”

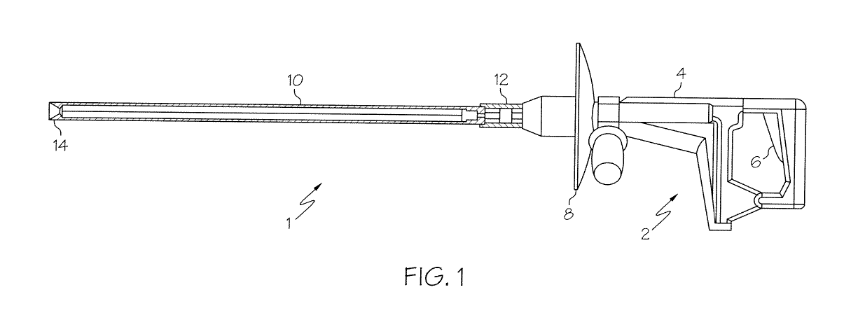

A thermite torch 1 is schematically illustrated in FIG. 1. The torch will typically comprise a handle 2 that includes an ignition module and power supply (typically a battery). Optionally, the handle has an O₂ generator 4 and trigger 6. The trigger can turn the shut off oxygen flow to the torch. A thermal shield 8 on the handle can protect the user's hands from heat. The thermite rod 10 can be made with a socket 12 for attaching/detaching to the handle. Molten metal is ejected through a nozzle 14 at the end of the rod. The nozzle can be attached to the rod. In another embodiment, the rod can be inserted into the torch body. As an alternative, or in addition to, the O2 generator in the handle, the thermite rod may contain excess O2 generator to force metal from the nozzle. An O2-generator can be in the torch rod for full-on operation, or in the gun handle for on/off/on operation.

The thermite composition is preferably a bimodal blend. Optionally, a powder for in-situ oxygen generation can be mixed into the thermite composition. A composition for generating oxygen can be loaded either into the rod or the handle, which will eliminate the need for a tank of compressed oxygen. Upon the mixing of all constituents, the nanoparticles will fill the interstitial voids among all the micron-sized powders, maximizing the packing density of the total mix of solid particles.

What is claimed:

1. A thermite torch comprising a thermite composition, wherein the thermite composition comprises 10% to 40% nanoparticles and 50% to 90% microparticles.

2. A thermite torch comprising a thermite composition, wherein the thermite composition comprises at least 10% nanoparticles, wherein the composition has a stable burn rate, such that, when tested by blending in an additional 10% of the nanoparticles and formed into a 10% modified rod, the burning rate of the rod made of the 10%-added composition increases by 10% or less when compared to the burn rate of a rod of the thermite composition; in this test, both rods are made by weighing percentages of nanoparticle powders; filling them into a thin-wall 0.5 inch (1.3 cm) inner diameter steel tube; and then agitating the tube by tumbling or vibration to achieve maximize packing density.

3. The thermite torch of claim 2 wherein the thermite composition comprises 10% to 40% nanoparticles and 50% to 90% microparticles.

4. The thermite torch of claim 1 wherein the thermite composition comprises at least 1% of an O2 generator.

5. The thermite torch of claim 1 wherein the nanoparticles are in the size range of 1-100 nanometer and wherein the microparticles are in the 1-10 micrometer range.

6. The thermite torch of claim 5 comprising a handle, a thermite rod comprising the thermite composition, a thermal shield disposed between the handle and the thermite rod, and a nozzle at one end of the thermite rod.

7. The thermite torch of claim 5 wherein the thermite composition does not contain wires or ribbons.

8. The thermite torch of claim 5 wherein the thermite composition comprises 10 to 20% aluminum (Al) with about 80 to 90% metal oxide.

9. The thermite torch of claim 5 wherein the thermite composition comprises at least 1% of chlorate or perchlorate.

10. A thermite composition comprising a bimodal distribution of nano and microparticles, comprising from 5% to 70% nanoparticles, 29 to 94% microparticles, and at least 1% of an O2 generator.

11. A thermite torch comprising the thermite composition of claim 10.

12. A thermite torch, comprising:
a thermite rod attached to
a handle; wherein the handle comprises a compartment comprising an O2 generating solid, and
a conduit connecting the compartment with the thermite rod.

13. A method of welding or cutting metal, comprising:
igniting the torch of claim 1 and using the molten metal released by the torch to weld or cut a metal substrate.

14. A method of welding or cutting metal, comprising:
igniting the torch of claim 11 and using the molten metal released by the torch to weld or cut a metal substrate.

15. A method of welding or cutting metal, comprising:
igniting the torch of claims 12 and using the molten metal released by the torch to weld or cut a metal substrate.
